(19) United States
(12) Patent Application Publication
(10) Pub. No.: US 2026/0055286 A1
(43) Pub. Date: Feb. 26, 2026

(54) NON-AQUEOUS UV/LED DIGITAL INKS FOR PRINTING FLEXIBILE MATERIALS

(71) Applicant: ENGLER ITALIA S.R.L., CASNATE CON BERNATE (CO) (IT)

(72) Inventor: Bruno Piccirilli, CASNATE CON BERNATE (CO) (IT)

(73) Assignee: ENGLER ITALIA S.R.L., CASNATE CON BERNATE (CO) (IT)

(21) Appl. No.: 19/101,414

(22) PCT Filed: Aug. 10, 2022
(86) PCT No.: PCT/IB2022/057462

§ 371 Date: Feb. 5, 2025

(51) Int. Cl. C09D 11/30; B41M 5/00; B41M 7/00; C09D 11/101; C09D 11/107; D06P 1/52; D06P 5/20; D06P 5/30

(52) U.S. Cl. CPC C09D 11/30; B41M 5/0047; B41M 5/0064; B41M 7/0081; C09D 11/101; C09D 11/107; D06P 1/525; D06P 5/2005; D06P 5/30

(57) ABSTRACT

The use of non-aqueous digital UV/LED inks for printing a flexible material is disclosed, especially for printing fabrics and hides. Moreover, an improved process is disclosed for digitally printing on flexible materials, by using said non-aqueous digital UV and/or LED inks. The resulting printed flexible materials are soft and matt, with an excellent colour fastness to rubbing, while still conveniently maintaining the initial flexibility. Moreover, it should be appreciated that resulting printed flexible materials are also completely odourless, differently from the materials printed according to the prior art.

### FIELD OF THE INVENTION

The invention concerns the use of non-aqueous digital UV/LED inks for printing a flexible material, especially fabrics and hides. Moreover, the invention concerns an improved process for printing on flexible materials, using said non-aqueous digital UV and/or LED inks.

### BACKGROUND ART

Printing on textile materials with digital inks has not found widespread use so far, due to several drawbacks of the currently available inks.

The manufacturers of digital printing inks on textiles mainly turned to aqueous inks, i.e., inks based on water or aqueous latex, in order to obtain an acceptable hand of the finished printed fabric, especially in terms of flexibility of the printed fabric, but these methods require a considerable and expensive waste of water and energy.

CN106800817 highlights the disadvantages of aqueous UV inks and furthermore states that it is difficult to print, with such inks, textile materials and in particular cotton-polyester fabrics; therefore, it suggests the use of non-aqueous digital UV inks containing at least 59.2% (preferably 66%) by weight of a prepolymer having in particular an epoxy nature. However, these inks still lead to printed fabrics having an absolutely unacceptable or even zero flexibility.

CN106590167 suggests loading the heads of a UV apparatus for general purposes with non-aqueous digital UV inks containing an oligomer, but still the presence of said oligomer does not lead to satisfactory flexibility when applying such inks to a fabric. More recently CN107189549 has proposed leather printing with non-aqueous digital UV inks containing a mixture of monofunctional and polyfunctional acrylic monomers: as polyfunctional monomers are indicated a difunctional urethane acrylate, known as NeoRad U-6282, and bis-pentaerythritol hexacrylate (DPHA, hexafunctional). Said mixture, also combined with a levelling agent and other ingredients, corresponds to a very high glass transition temperature (Tg) of the ink. Inks of this type give the leather some good characteristics, but still, they reduce flexibility of the material in an absolutely unacceptable way, especially for textiles.

EP3412738A discloses an inking composition containing a photopolymerizable component, which includes a mixture of two monofunctional monomers forming homopolymers with different Tg (one with Tg equal to or greater than 20° C. and the other with Tg lower than 20° C.), comprising 0-30 percent (relative to the blend) of tetrahydrofurfuryl acrylate (THFA), because higher contents of THFA are said to make printed coating films to have less “curability”, i.e., less satisfactory polymerizability. In a previous patent application (IT 102019000019956) the Applicant has provided a novel printing process using a non-aqueous digital UV ink containing at least 70% by weight of tetrahydrofurfuryl-acrylate (THFA), said ink having a Tg equal to or lower than 5° C., surprisingly noting that said quantities of said particular monofunctional acrylic monomer provide very high flexibility, alongside an excellent colour fastness to rubbing, to printed fabrics.

Flexibility can be assessed and quantified by means of a “flexibility index”, that is the number of pleats that can be imparted to a textile material without damaging the print obtained, as measured with a Bally EL-18/6 flexometer.

Colour fastness to rubbing is a test evaluating the degree of colour transfer from the textile surface to other surface, and is performed according to UNI EN ISO 105-X12 (also known as Martindale test).

Still, there is a need for further inks suitable for digital printing of flexible materials, such as fabrics, having physical characteristics that make them suitable for ink-jet printing, that do not adversely impact the flexibility and elasticity of the flexible material once printed on it, alongside providing excellent colour fastness to rubbing, and that are inodorous once printed and with an acceptable toxicological profile.

Also, there is a need for improved processes for printing fabrics and other flexible materials, that are ecological and economic, saving water and energy, still maintaining high quality of printing and being capable of providing valuable printed products.

### BRIEF DESCRIPTION OF THE INVENTION

The object of the present invention is therefore to provide inks that can be advantageously used for digital printing of flexible materials, in particular ink-jet printing of flexible materials.

Furthermore, it is an object of the present invention to provide a process for digital printing of fabrics and flexible materials in general, that ameliorates the ecological, energetic and economic impact of the printing process and that provides a satisfactory print on flexible materials, without compromising the flexibility of the material itself. These objects have been achieved by the process and inks of the enclosed claims.

### BRIEF DESCRIPTION OF FIGURES

The characteristics and the advantages of the present invention will become apparent from the following detailed description, the working examples provided for illustrative purposes, and the annexed Figures wherein:

FIG. 1 shows a canvas fabric (left) and a leather remnant (right), both printed as in example 3, through Epson DX5 print-heads,

FIG. 2 shows a cotton fabric printed in example 3, through Epson DX5 print-heads,

FIG. 3 shows a denim fabric (left) and a cotton jersey fabric (right), both printed as in example 3, through Epson DX5 print-heads,

FIG. 4 shows a canvas fabric (left) and a leather remnant (right), both printed as in example 3, through Ricoh Gen 5 print-heads,

FIG. 5 shows a cotton fabric printed in example 3, through Ricoh Gen 5 print-heads, and

FIG. 6 shows a cotton jersey fabric (left) and a denim fabric (right), both printed as in example 3, through Ricoh Gen 5 print-heads.

### DETAILED DESCRIPTION OF THE INVENTION

The present invention is directed to the use of selected non-aqueous digital UV/LED inks for printing flexible materials.

Digital UV/LED inks are inks suitable for digital inkjet printing, comprising monomers or oligomers that are curable by UV- and/or LED-radiation.

By “flexible materials” it is meant any printable material, including textile materials, plastic materials and films, that is capable of bending without breaking.

The term “textile materials” includes fabrics obtained from natural and/or synthetic fibers, technical fabrics, coated fabrics, and in particular cotton, wool, silk, jute, hemp, linen, polyester fibers, acrylic fibers, polyamide fibers and related blends or combinations, as well as natural and/or synthetic hides, i.e. items made of natural and/or synthetic skins or leather.

The digital UV/LED ink for the use of the invention comprises at least 75% by weight, based on the ink weight, of at least one monofunctional monomer having a viscosity equal to or lower than 0.012 Pa*s (=12 centipoises), preferably of lower than 0.010 Pas, more preferably of lower than 0.005 Pa*s, as measured by Brookfield rotational viscometer at 60 rpm and 25° C.

Preferably, said at least one monofunctional monomer is selected from acrylic monomers.

Suitable monofunctional acrylic monomers are disclosed in Table 1 below:

TABLE 1

| Chemical | | | | |
|---|---|---|---|---|
| abbreviation | Description | CAS | Tg (° C.) | Structural formula |
| CTFA | Cylic trimethylolpropane formal acrylate | 66492-51-1 | 10 | 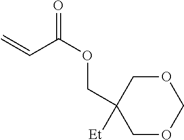 |
| TMCHA | Trimethyl cyclohexyl Acrylate | 86178-38-3 | 43 | 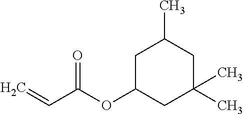 |
| LA | Lauryl Acrylate | 2156-97-0 | −30 | 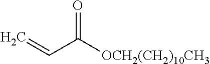 |
| CA | Caprolactone Acrylate | 110489-05-9 | −53 | 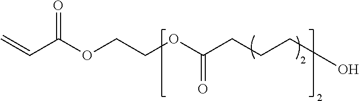 |
| THFA | tetrahydrofurfuryl- acrylate | 2399-48-6 | −12 | 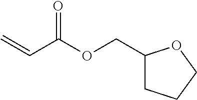 |

More preferably, said at least one monofunctional monomer is at least one acrylic monomer selected from the group consisting of cyclic trimethylolpropane formal acrylate (CTFA), trimethyl cyclohexyl acrylate (TMCHA), lauryl acrylate (LA), caprolactone acrylate (CA), optionally in admixture with tetrahydrofurfuryl-acrylate (THFA), and mixtures thereof.

Preferably, said at least one monofunctional monomer is vinyl methyl-oxazolidinone (VMOX) monofunctional monomer, as disclosed in Table 2:

TABLE 2

| Chemical | | | Tg | |
|---|---|---|---|---|
| abbreviation | Description | CAS | (° C.) | Structural formula |
| VMOX | Vinyl methyl oxazolidinone | 33995- 98-0 | 19° C. | 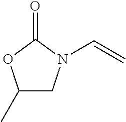 |

Preferably, said at least one monofunctional acrylic monomer is a mixture comprising 2 or 3 of the monomers selected from trimethylolpropane formal acrylate (CTFA), trimethyl cyclohexyl acrylate (TMCHA), lauryl acrylate (LA), caprolactone acrylate (CA), tetrahydrofurfuryl-acrylate (THFA), and vinyl methyl-oxazolidinone (VMOX). In some embodiments, the digital UV/LED ink for the use of the invention comprises at least 80% by weight, based on the ink weight, of at least one monofunctional acrylic monomer being a mixture comprising vinyl methyl-oxazolidinone (VMOX).

Preferably, said at least one monofunctional acrylic monomer is a mixture comprising 10-80% by weight of TMCHA, based on the ink weight.

Preferably, said at least one monofunctional acrylic monomer is a mixture comprising 60-90% by weight of CTFA, based on the ink weight.

Preferably, the digital UV/LED ink for the use of the invention further comprises other components, i.e. co-formulants and/or additives, such as a photo-initiator, preferably in a concentration of 5-10% by weight, a levelling agent, preferably in a concentration of 2-5% by weight, or pigments or colourants, preferably in a concentration of 10-20% by weight, based on the ink weight.

A suitable levelling agent is a cross-linkable urethane-acrylate silicone which has levelling, adhesion to the substrate and sliding functions.

The digital UV/LED ink for the use of the invention is available in a wide colour range (CMYK, white, fluorescent, varnish, etc.).

For many years, the Epson DX5 print-head was the most commonly used type on the market, but with the introduction of other printheads, such as the Ricoh Gen 5, applications and performance have improved.

The Epson DX5 is characterized by its 8 rows of nozzles, with each row having 180 nozzles, for a total of 1440 nozzles, leading to a resolution of 1440 dpi (i.e. dots per inch). The Ricoh Gen5 offers only 4 rows of nozzles, but each row has 320 nozzles for a total of 1280 nozzles, however the dpi resolution is very similar.

The smallest drop of the Epson DX5 is 5 pl (i.e. picolitre), whereas for Ricoh Gen5 it is a slightly larger, being 7 pl, which could make a difference in very fine printing works. With respect to performances, one difference is the number of channels supported by these heads, with 8 lines, Epson DX5 supports 8 separate channels, which could be used for 8 different colors, whereas Ricoh Gen5 can only use a maximum of 4 channels and thus 4 colours.

With a 60 kHz jet frequency, the Ricoh Gen5 is much faster than the 8 kHz Epson DX5, even if the speed difference isn't as noticeable as it could seem.

Epson print-heads work better with 0.003-0.006 Pa*s viscosity inks, whereas Ricoh print-heads work better with viscosity 0.009-0.012 Pa*s.

In view of the above, when Epson print-heads are in use for printing, preferably, the digital UV/LED ink for the use of the invention comprises TMCHA, more preferably in a concentration of 10-80% by weight, based on the ink weight.

When Ricoh print-heads are in use for printing, preferably, the digital UV/LED ink for the use of the invention comprises CTFA, more preferably in a concentration of 60-90% by weight, based on the ink weight.

Exemplary compositions of the most preferred inks are reported in the table below:

| | for Epson print-heads | | | | for Ricoh print-heads | | | |
|---|---|---|---|---|---|---|---|---|
| | A | B | C | D | E | F | G | H |
| TMCHA | 80 | 60 | 10 | 50 | | | | |
| CTFA | | | | | 85 | 65 | 65 | 65 |
| VMOX | 5 | 20 | 70 | 30 | | 15 | 15 | 20 |
| LA | | | 5 | | | 5 | | |
| CA | | | | 5 | | | 5 | |
| Pigment paste | 13 | 13 | | | 13 | 13 | 13 | 13 |
| Co-formulants/additives | 2 | 2 | | | 2 | 2 | 2 | 2 |

The monofunctional monomers in the ink for the use of the invention preferably have a glass transition temperature of −55° C. to 45° C., as measured by differential scanning calorimetry.

Preferably, the monofunctional monomers have a glass transition temperature lower than 50° C., more preferably lower than 20° C., most preferably lower than or equal to 10° C., as measured by differential scanning calorimetry.

The “glass transition temperature” (Tg) is the temperature at which a polymer passes from a rigid and amorphous state (glassy state) to a flexible state. Tg is measured by differential scanning calorimetry, also known as DSC (differential scanning calorimetry), that is, together with differential thermal analysis (DTA), the main thermal analysis technique that can be used to characterize many types of materials including polymers, metals and ceramic materials.

The ink for the use of the present invention, comprising at least 90% by weight of at least one monofunctional monomer described above, is at liquid state at room temperature (i.e. 15-25° C.), so that it is not necessary to melt it before use; moreover, said ink has a viscosity that makes it suitable for being used in the currently available ink jet printers, e.g., as it does not clog the printer's heads.

Also, the digital UV/LED ink for the use of the present invention, comprising at least 90% by weight of at least one preferred monofunctional monomers described above, is completely inodorous, so that the material printed with said ink is advantageously inodorous consequently.

A material is “inodorous” when it has no sensory attribute perceptible by the olfactory organ on sniffing. A test in accordance with the European standard EN 1230-2 (commonly known as the Robinson test, i.e. a sensory test for testing paper and board intended to come into contact with foodstuffs) has performed by enrolling a panel of trained assessors. The test has confirmed that the flexible material printed using the digital UV/LED inks of the present invention results to be completely inodorous or odourless.

Therefore, the present invention is also directed to a flexible material printed with digital UV/LED ink, wherein the printed flexible material is inodorous according to the European standard EN 1230-2.

Also, the digital UV/LED ink for the use of the present invention, comprising at least 90% by weight of at least one monofunctional monomer described above, has a suitably acceptable toxicological profile.

Moreover, the digital UV/LED ink for the use of the present invention has excellent adhesion to the printed flexible material, so that the latter has an excellent colour fastness to rubbing, still conveniently maintaining its initial flexibility. The latter has been evaluated by measuring the elongation index according to ASTM D412. Particularly, ASTM D412 measures the elasticity of a material while under tensile strain, as well as its behavior after testing when the material is no longer being stressed. ASTM D412 is conducted on a universal testing machine (also called a tensile testing machine) at a rate of 500±50 mm/min until the specimen fails.

Preferably, the elongation index of the printed flexible materials of the present invention is 10-15%.

The present invention is also directed to a process for digitally printing a flexible material comprising the steps of:
i. providing a flexible material;
ii. printing a digital UV/LED ink comprising at least 90% by weight, based on the ink weight, of at least one monofunctional monomer, having a viscosity of less than 0.012 Pa*s as measured by Brookfield rotational viscometer at 60 rpm and 25° C., on the flexible material; and
iii. curing the ink-printed flexible material, by exposing the latter to a UV/LED lamp.

It should be understood that all the preferred aspects of the non-aqueous digital UV inks as above reported are likewise preferred also within the process for digitally printing of the present invention.

The flexible material of step i. has been previously disclosed and defined. Preferably, the flexible material is a textile material, plastic material or a film; more preferably, it is a textile material, such as natural and/or synthetic hides or a fabric obtained from natural and/or synthetic fibres, such as cotton, wool, etc.

The step ii. of printing on the flexible material is carried out by widespreading the ink on the material surface through printer head nozzles, preferably by means of an ink-jet printer.

The UV/LED lamp is a lamp emitting UV and/or LED radiations.

UV and/or LED radiations cure the ink printed on the flexible material. Preferably, the exposition to UV and/or LED radiations lasts for 1-5 seconds, more preferably 1-2 seconds.

It has been surprisingly found that the step of curing the ink printed on the flexible material can be accelerated by further exposing the flexible material under an excimer lamp, before exposing it under the UV/LED lamp.

Excimer lamps are a source of ultraviolet (UV) light produced by spontaneous emission of excimer (exciplex) molecules.

Excimer lamps operate over a wide range of wavelengths in the ultraviolet (UV) and vacuum ultraviolet (VUV) spectral regions: the formation of excited dimers (excimers), which spontaneously transiting from the excited state to the ground state result in the emission of UV-photons.

Therefore, the present invention is also directed to a process for digitally printing a flexible material comprising the steps of:
i. providing a flexible material;
ii. printing a digital UV/LED ink comprising at least 70% by weight, based on the ink weight, of one or more monofunctional monomers, having a viscosity of less than 0.012 Pa*s as measured by Brookfield rotational viscometer at 60 rpm and 25° C., on the flexible material; and
iii. curing the ink-printed flexible material, by exposing the latter to an excimer lamp and then to a UV/LED lamp.

Besides accelerating the overall curing of the ink, the additional sub-step of exposing the printed flexible material to an excimer lamp, before the UV/LED lamp, ameliorates the printing process performances, since ink curing occurs more in depth. Moreover, the printed area on the printed materials obtained by the process of the invention implemented with excimer lamps appear more soft and matt.

Preferably, the excimer lamp implemented in the process of the invention emits radiations having a wavelength of 160-180 nm, more preferably of 170-175 nm, most preferably of about 172 nm.

Preferably, the exposition to excimer lamp lasts for 1-5 seconds, more preferably 1-2 seconds.

The UV/LED lamp, for curing the digital UV/LED ink printed on the flexible material after the excimer lamp, preferably emits radiations having a wavelength of 350-410 nm, more preferably of 360-390 nm.

Advantageously, excimer lamps can be easily implemented in the currently available ink jet printers with UV/LED lamps, to carry out the process according to preferred embodiments of the invention.

Preferably the step of curing the ink printed on the flexible material is carried out in an inert atmosphere, e.g., under N₂ atmosphere.

Preferably, the digital UV/LED ink, printed on the flexible material according to the process of the invention, comprises at least one monofunctional monomer selected from the group consisting of monofunctional acrylic monomers, vinyl methyl-oxazolidinone (VMOX), and mixtures thereof.

More preferably, the monofunctional acrylic monomers are selected from the group consisting of cyclic trimethylolpropane formal acrylate (CTFA), trimethyl cyclohexyl acrylate (TMCHA), lauryl acrylate (LA), caprolactone acrylate (CA), tetrahydrofurfuryl-acrylate (THFA) monomers, and mixtures thereof; most preferably, are selected from the group consisting of cyclic trimethylolpropane formal acrylate (CTFA), trimethyl cyclohexyl acrylate (TMCHA), lauryl acrylate (LA), caprolactone acrylate (CA), and mixtures thereof.

Most preferably, the digital UV/LED ink, printed on the flexible material according to the process of the invention, comprises at least 90% by weight, based on the ink weight, of one or more of cyclic trimethylolpropane formal acrylate (CTFA), trimethyl cyclohexyl acrylate (TMCHA), lauryl acrylate (LA), caprolactone acrylate (CA), tetrahydrofurfuryl-acrylate (THFA) monomers, and mixtures thereof.

For the implementation of the process of the invention, currently commercially available printers used for digital UV-printing are appropriate; such printers are equipped with an UV or LED lamp. Optionally, said printers can be further equipped with an excimer lamp to carry out the process according to further aspects of the invention.

The present invention is also directed to a process for digitally printing a flexible material comprising the steps of:
i. providing a flexible material;
ii. printing a digital UV/LED ink comprising at least 70% by weight, based on the ink weight, of at least one monofunctional monomer, having a viscosity of less than 0.012 Pa*s as measured by Brookfield rotational viscometer at 60 rpm and 25° C., on the flexible material; and
iii. curing the ink-printed on the flexible material, by exposing the latter to an excimer lamp and then to a UV/LED lamp;
   wherein the at least one monofunctional monomer is selected from the group consisting of cyclic trimethylolpropane formal acrylate (CTFA), trimethyl cyclohexyl acrylate (TMCHA), lauryl acrylate (LA), caprolactone acrylate (CA), tetrahydrofurfuryl-acrylate (THFA) monomers, vinyl methyl-oxazolidinone (VMOX), and mixtures thereof.

Preferably, the digital UV/LED ink comprises at least 90% by weight, based on the ink weight, of the at least one monofunctional monomer.

All the embodiments above disclosed of the printing process of the invention represent an energetic, economic and ecologic improvement compared to printing processes based on water, or on aqueous latex, or pigment digital printing, as currently adopted.

The present invention is moreover directed to an ink-jet printer for digital UV/LED printing of flexible materials, the ink-jet printer comprising a UV/LED lamp and an excimer lamp, the latter being positioned upstream the UV/LED lamp.

It should be understood that all the possible combinations of the preferred aspects of the non-aqueous digital UV inks, the process of printing, and the printers of the present invention are also described, and therefore similarly preferred.

Working examples of the present invention are provided below for illustrative and non-limiting purposes.

### EXAMPLES

### Example 1 (Comparative)

A textile material made from cotton fibers was printed using, as suggested by CN106800817, a non-aqueous digital UV ink containing more than 59.2% of an epoxy prepolymer. The printed textile material obtained sometimes had a flexibility index equal to 3 and sometimes even a flexibility index of zero (not flexible); the print crumbled immediately when testing with the flexometer.

### Example 2 (Comparative)

Example 1 was repeated by printing on a textile material obtained from a blend of cotton-polyester fibers; in this case also, the flexibility obtained was unacceptable.

### Example 3

The following non-aqueous digital UV/LED inks, according to the invention, have been prepared:

| | for Epson print-heads | | | | for Ricoh print-heads | | | |
|---|---|---|---|---|---|---|---|---|
| | A | B | C | D | E | F | G | H |
| TMCHA | 80 | 60 | 10 | 50 | | | | |
| CTFA | | | | | 85 | 65 | 65 | 65 |
| VMOX | 5 | 20 | 70 | 30 | | 15 | 15 | 20 |
| LA | | | 5 | | | 5 | | |
| CA | | | | 5 | | | 5 | |
| Pigment paste | 13 | 13 | | | 13 | 13 | 13 | 13 |
| (CMYK and white) | | | | | | | | |
| Co-formulants/additives | 2 | 2 | | | 2 | 2 | 2 | 2 |

Different types of flexible materials have been provided in duplicate, for being printed with the above inks:
i) canvas fabric,
ii) leather remnant,
iii) cotton fabric,
iv) denim fabric, and
v) cotton jersey fabric.

One duplicate has been printed with Epson DX5 print-heads, and the other duplicate with Ricoh Gen 5 print-heads, thus giving the 10 printed flexible materials, as follows:

| | Epson print-heads | | | | Ricoh print-heads | | | |
|---|---|---|---|---|---|---|---|---|
| | A | B | C | D | E | F | G | H |
| i) canvas fabric, | x | | | | x | | | |
| ii) leather remnant, | | x | | | | x | | |
| iii) cotton fabric, | | | x | | | | x | |
| iv) denim fabric, and | | | | x | | | | x |
| v) cotton jersey fabric | x | | | | x | | | |

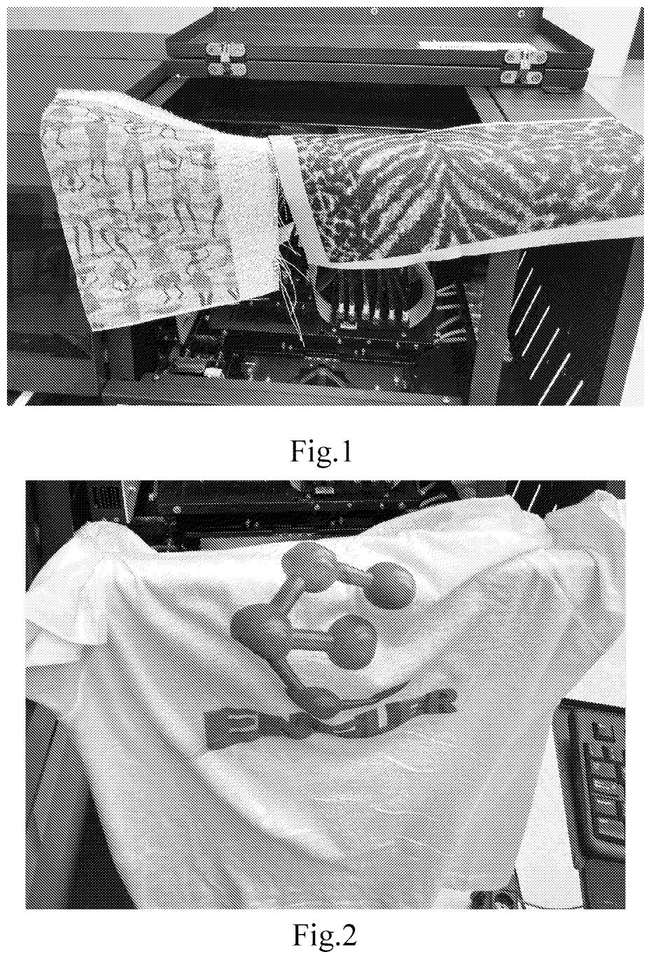

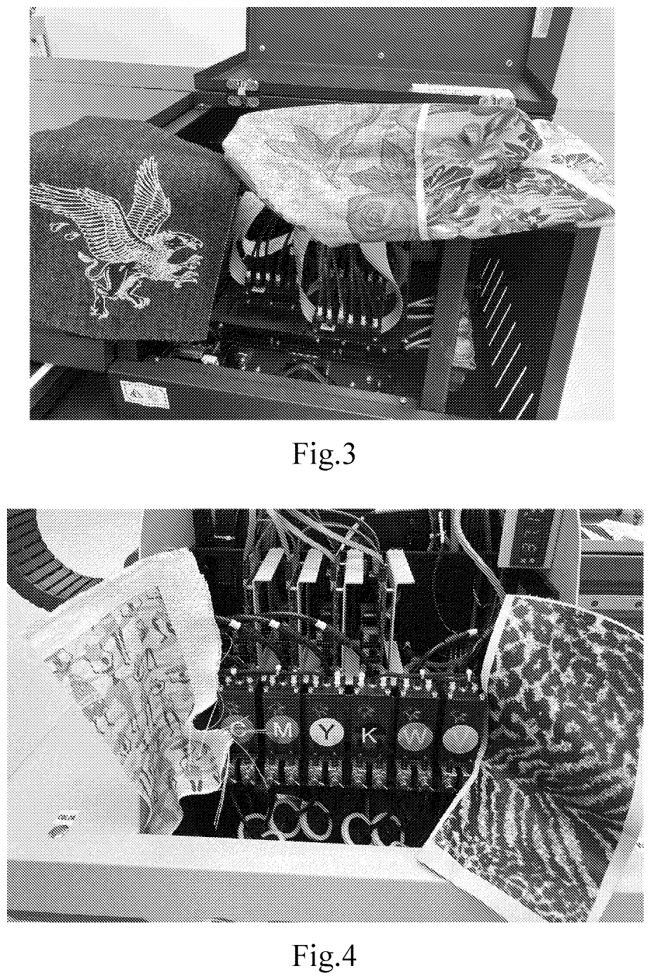

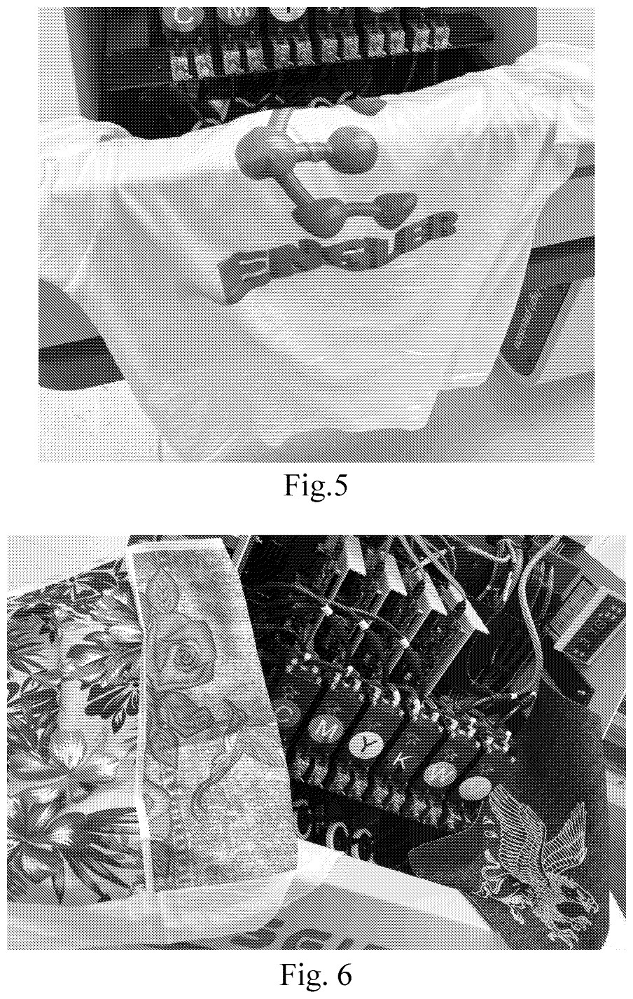

Each of said 10 flexible materials has been printed without and with the use of excimer lamp, however the quality differences are not visible in pictures, so that FIGS. 1-6 only show the 10 printed flexible materials with UV/LED lamp.

Printing has been carried out as follows: the flexible materials have been printed by digital UV ink-jet printing with the above inks of the invention (CMYK and white colours), then the printed flexible materials have been exposed under a UV/LED lamp, emitting at 360-390 nm. The UV/LED lamp has been used at 80% of maximum power.

When also the excimer lamp was used, the printed flexible materials have been exposed under an excimer lamp emitting at 172 nm (purchased from UV Ray) in inert atmosphere, before undergoing the exposure to the UV/LED lamp.

After 48 hours from printing, specific tests have been carried out to assess the quality of the printed flexible materials so obtained.

Firstly, it was surprisingly noted that none of the printed flexible materials had unpleasant odour, being conversely completely inodorous (according to the European standard EN 1230-2.

Moreover, all the printed materials maintained appreciably high flexibility, as measured in terms of elongation index (10-15%) according to ASTM D412.

Additionally, the ink's adhesion to the materials was optimal and provided excellent colour fastness to rubbing. Indeed, Grey Scales (UNI EN ISO 105-X12) were used for assessing colour change and staining during colour fastness testing. These scales are used for visual assessment to ascribe a rating from 1 to 5, with 5 being ‘good’ and 1 being ‘poor’. All the printed materials were rated with 4, thus confirming an overall high quality of the printing process.

Also, the resulting printed flexible materials are soft and matt, as the initial non-printed flexible materials, however, those undergone to excimer lamp exposure, before the UV/LED lamp, have resulted to be even more soft and matt, as well as more pleasant and smooth at the touch.

1.-5. (canceled)

6. A process for digitally printing a flexible material comprising the steps of:
i. providing a flexible material;
ii. printing a non-aqueous digital UV/LED ink comprising at least 75% by weight, based on the ink weight, of at least one monofunctional monomer, having a viscosity of less than 0.012 Pa*s as measured by Brookfield rotational viscometer at 60 rpm and 25° C., on the flexible material; and
iii. curing the ink-printed flexible material, by exposing the latter to a UV/LED lamp, thus obtaining an ink-printed flexible material which is inodorous according to European Standard EN 1230-2,
wherein said at least one monofunctional monomer is selected from the group consisting of cyclic trimethylolpropane formal acrylate (CTFA), trimethyl cyclohexyl acrylate (TMCHA), lauryl acrylate (LA), caprolactone acrylate (CA), vinyl methyl-oxazolidinone (MVOX) and mixtures thereof.

7. The process of claim 6, wherein in step iii. the ink-printed flexible material is cured by exposing said ink-printed flexible material to an excimer lamp and then to a UV/LED lamp.

8. The process of claim 6, wherein said at least one monofunctional monomer is in admixture with tetrahydrofurfuryl-acrylate (THFA).

9. The process of claim 6, wherein said at least one monofunctional monomer is a mixture comprising 2 or 3 monomers selected from the group consisting of cyclic trimethylolpropane formal acrylate (CTFA), trimethyl cyclohexyl acrylate (TMCHA), lauryl acrylate (LA), caprolactone acrylate (CA), vinyl methyl-oxazolidinone and tetrahydrofurfuryl-acrylate (THFA).

10. The process of claim 7, wherein the excimer lamp emits radiations having a wavelength of 160-180 nm, while the UV/LED lamp emits radiations having a wavelength of 350-410 nm.

11. The process of claim 6, wherein the digital UV/LED ink comprises at least 80% by weight, based on the ink weight, of at least one monofunctional monomer being a mixture comprising vinyl methyl-oxazolidinone (VMOX).

12. The process of claim 6, wherein said at least one monofunctional monomer is a mixture comprising 10-80% by weight of TMCHA, based on the ink weight.

13. The process of claim 6, wherein said at least one monofunctional monomer is a mixture comprising 60-90% by weight of CTFA, based on the ink weight.

14. Flexible material printed by the process of claim 6, wherein the printed flexible material is inodorous according to the European standard EN 1230-2.

15. (canceled)

16. The process of claim 6, wherein said at least one monofunctional monomer has a glass transition temperature of −55° C. to 45° C., as measured by differential scanning calorimetry.

17. The process of claim 6, wherein said flexible material is a textile material, or a plastic material, or a film.
